(19) United States
(12) Patent Application Publication
(10) Pub. No.: US 2004/0095758 A1
(43) Pub. Date: May 20, 2004

(54) Flashlight with length adjustable body

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/294,632

(22) Filed: Nov. 15, 2002

(51) Int. Cl. F21L 4/04

(52) U.S. Cl. 362/204; 362/202

(57) ABSTRACT

A flashlight includes a body which is composed of a first section and a second section. The first section includes a cap and a bulb and reflection hood assembly connected to a first end thereof and a second end of the first section is retractably received in the second section. Batteries are received in the first section and the second section. A spring is connected to a first conductive plate received in the second section and biases the batteries to contact a tail end on the end so as to form a circuit to light up the bulb. The number of batteries can be adjusted by retractably moving the first section relative to the second section.

### FIELD OF THE INVENTION

The present invention relates to a flashlight that has a length adjustable body so as to reduce the length of the body to let the flashlight work with less number of batteries.

### BACKGROUND OF THE INVENTION

A conventional flashlight is shown in FIGS. 1 and 2, and generally includes a tubular body 10 which has an open end-14 and a closed end. A head 16 including a bulb and a reflection hood is received in the open end 14 and a conductive plate 11 is received in the body 10 and a spring 141 with an end plate are connected to an end of the plate 11. Batteries 15 are received in the body 10 and biased by the spring 141 so that the negative end of the last battery is biased by the spring 131 and the positive end of the battery located at the opposite end of the series of the batteries 15 contacts the tail end 161 on the head 16. A cap 13 is connected to the open end by the threaded section 12. It is to be noted that the number of the batteries 15 is fixed so that the users have to prepare the exact number of batteries 15 to operate the flashlight. Nevertheless, as shown in FIG. 3, the spring 141 is loosened after a period of use and results in that the first battery cannot reach the tail end 161

The present invention intends to provide a flashlight that has an adjustable body so that the length of the body can be reduced to allow the user to operate the flashlight by less number of battery.

### SUMMARY OF THE INVENTION

In accordance with one aspect of the present invention, there is provided a flashlight which comprises a body composed of a first section and a second section. The first section includes a cap connected to a first end thereof and a bulb and reflection hood assembly is received in the first end of the first section. A first conductive plate with a spring connected to an end thereof is received in the second section and the spring contacts against an inside of a close end of the second section. A second conductive plate has a section overlapped to the first conductive plate and is received in the first section. A button is connected to the second conductive plate. A second end of the first section is retractably inserted in the second section.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional flashlight;

FIG. 2 shows batteries received in the conventional flashlight;

FIG. 3 shows the batteries in the conventional flashlight cannot contact the tail end of the head;

FIG. 4 is an exploded view to show the flashlight of the present invention;

FIG. 5 is a perspective view to show a shortened embodiment of the flashlight of the present invention;

FIG. 6 shows a cross sectional view of the flashlight as shown in FIG. 5;

FIG. 7 is a perspective view to show an extended embodiment of the flashlight of the present invention;

FIG. 8 shows a cross sectional view of the flashlight as shown in FIG. 7;

FIG. 9 is an exploded view to show another embodiment of the flashlight of the present invention;

FIG. 10 is a cross sectional view to show the shortened embodiment of the flashlight as shown in FIG. 9, and

FIG. 11 shows a cross sectional view to show the extended embodiment of the flashlight as shown in FIG. 9.

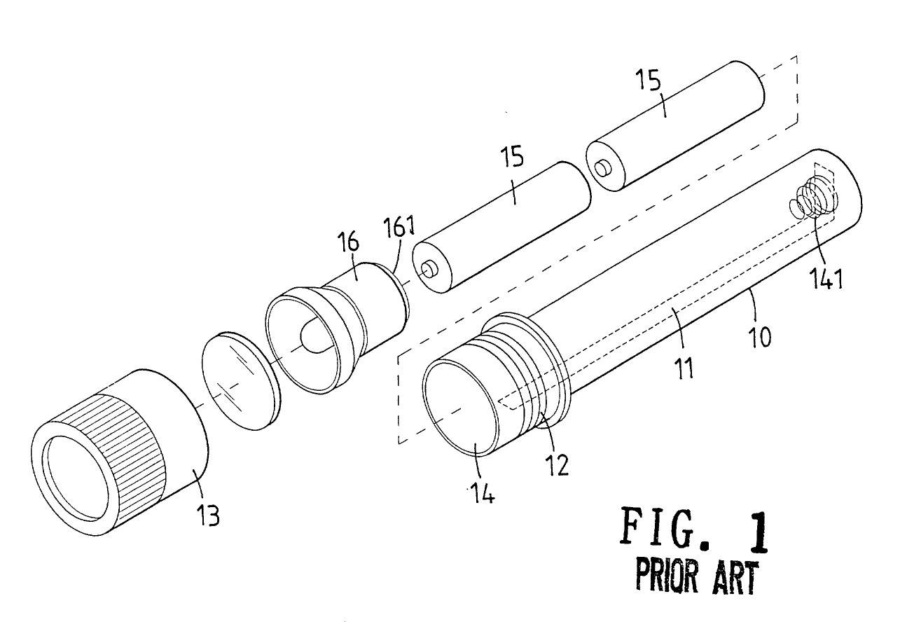

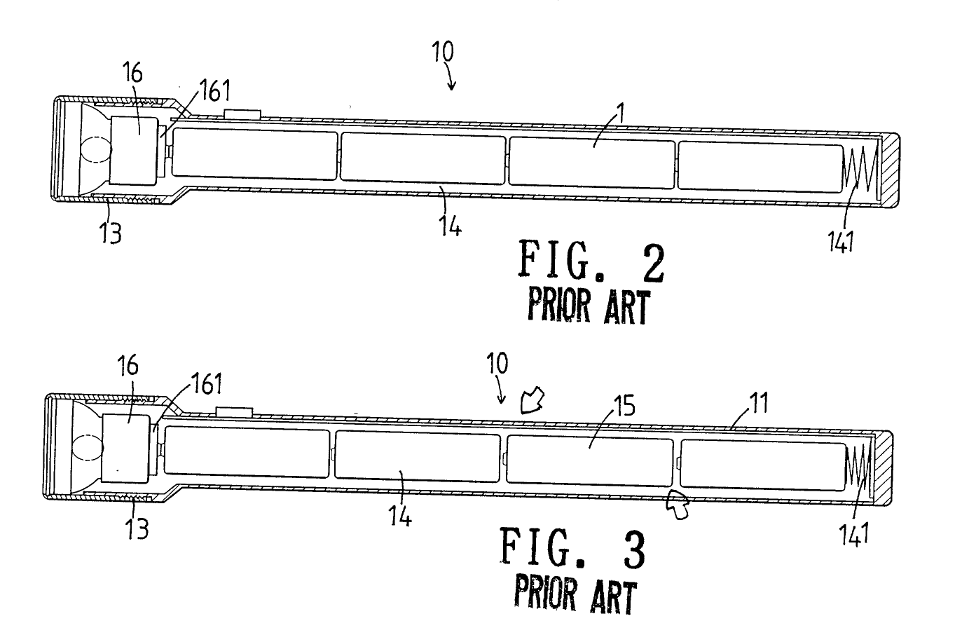

### DETAILED DESCRIPTION OF THE PREFERRED EMBODIMENT

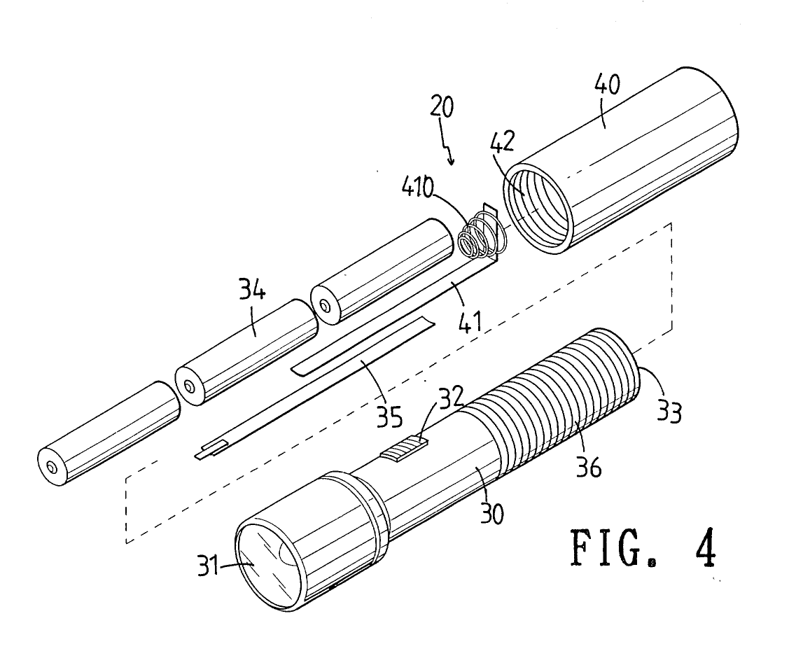

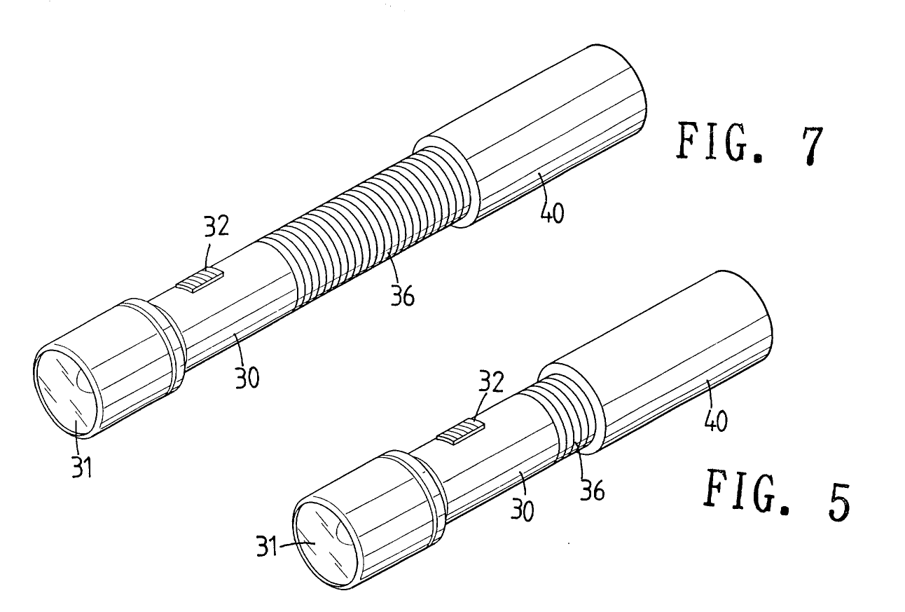

Referring to FIGS. 4 to 6, the flashlight 20 of the present invention comprises a body which is composed of a first section 30 and a second section 40. The first section 30 includes a cap 31 with a lens connected to a first end thereof and a bulb and reflection hood assembly 36 is received in the first end of the first section 30.

A first conductive plate 41 is received in the second section 40 and has a spring 410 connected to an end plate of the conductive plate 41. The spring 410 contacts against an inside of a close end of the second section 40. A second conductive plate 35 has a section overlapped to the first conductive plate 41 and is received in the first section 30. The overlap portion of the first conductive plate 41 and the second conductive plate 35 is in contact with each other all the time. A button 32 is connected to the second conductive plate 35 and can be accessed from outside of the first section 30. A first threaded section 36 is defined in an outer periphery of the second end 33 of the first section 30. The second section 40 has a second threaded section 42 defined in an inner periphery thereof so that the first threaded section 36 is engaged with the second threaded section 42.

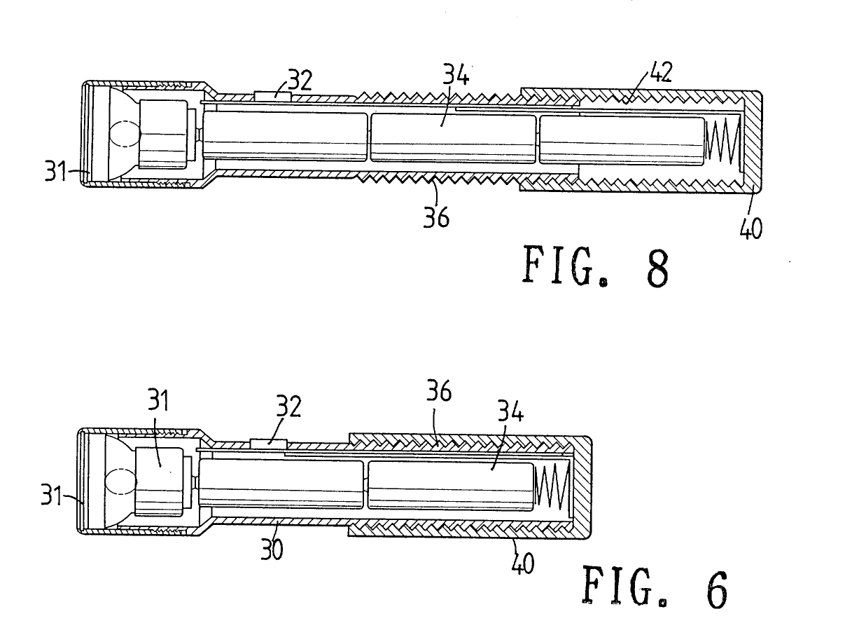

Batteries 34 are received in the first section 30 and the second section 40 and contact the spring 410 and the tail end 161 of the bulb and reflection hood assembly 36, so that the bulb in the bulb and reflection hood assembly 36 lights up when operating the button 32. As shown in FIG. 6, only two batteries 34 are needed.

Referring to FIGS. 7 and 8, the length of the body can be extended by rotating the second section 40 such that three batteries 34 are needed.

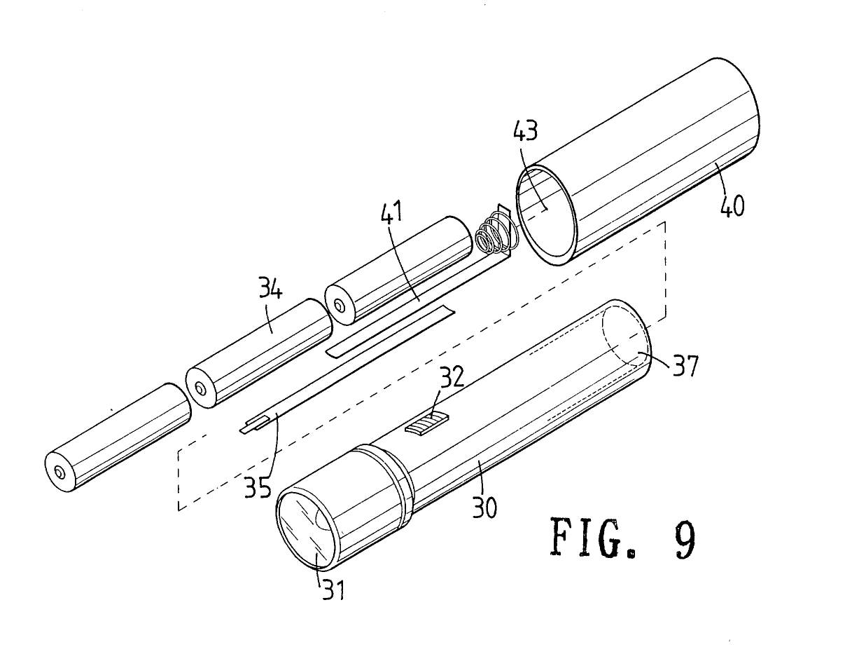

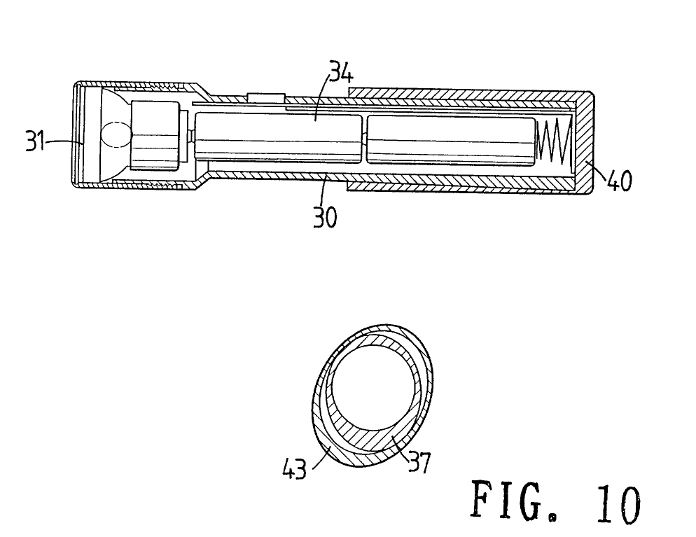

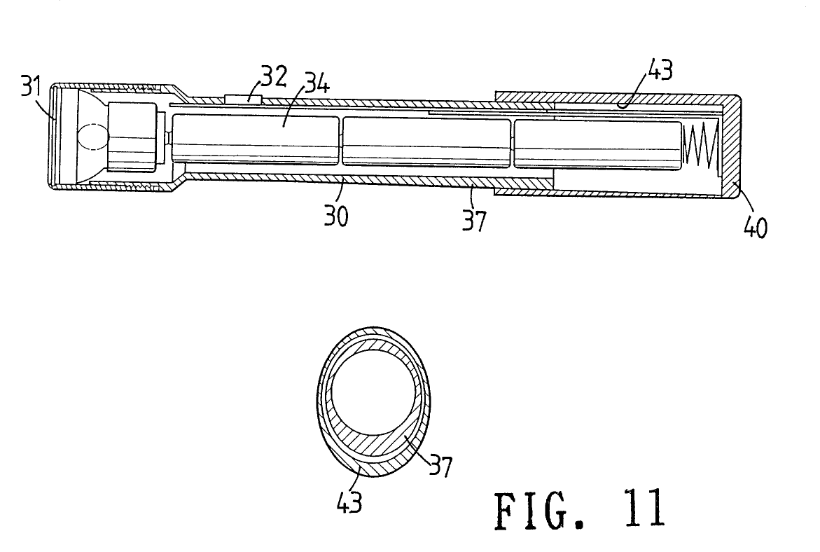

Referring to FIGS. 9 to 11, the connection of the first section 30 and the second section 40 may use two oval-shaped tubes which can be fixed with each other by rotating one of which relative to the other. The second end 37 of the first section 30 has an oval cross section and the second section 40 has an open end 43 which is an oval-shaped opening in which the second end of the first section 30 is rotatably engaged. A length of a major axis of the oval cross section of the first section 30 is smaller than a length of a minor axis of the open end of the second section 40. When the two minor axes of the first section 30 and the second section 40 are parallel with each other, the first section 30 can freely moved in the second section 40. When rotating the either one of the two sections 30, 40, the first section 30 is stocked in the second section 40 so as to fix the length of the body of the flashlight.

While we have shown and described the embodiment in accordance with the present invention, it should be clear to those skilled in the art that further embodiments may be made without departing from the scope of the present invention.

What is claimed is:

1. A flashlight comprising:
a body composed of a first section and a second section, the first section includes a cap connected to a first end thereof and a bulb and reflection hood assembly received in the first end of the first section, and
a first conductive plate received in the second section and having a spring connected to an end of the conductive plate, the spring contacting against an inside of a close end of the second section, a second conductive plate having a section overlapped onto the first conductive plate and received in the first section, a button connected to the second conductive plate, a second end of the first section retractably inserted in the second section.

2. The flashlight as claimed in claim 1, wherein the first section has a first threaded section defined in an outer periphery of the second end thereof and the second section has a second threaded section defined in an inner periphery thereof, the first threaded section engaged with the second threaded section.

3. The flashlight as claimed in claim 1, wherein the second end of the first section has an oval cross section and the second section has an open end which is an oval-shaped opening in which the second end of the first section is rotatably engaged.

4. The flashlight as claimed in claim 3, wherein a length of a major axis of the oval cross section of the first section is smaller than a length of a minor axis of the open end of the second section.
